(19) United States
(12) Patent Application Publication
(10) Pub. No.: US 2012/0330472 A1
(43) Pub. Date: Dec. 27, 2012

(54) POWER CONSUMPTION PREDICTION SYSTEMS AND METHODS

(75) Inventor: John Christopher Boot, Sandy Springs, GA (US)

(73) Assignee: GENERAL ELECTRIC COMPANY, Schenectady, NY (US)

(21) Appl. No.: 13/165,107

(22) Filed: Jun. 21, 2011

(51) Int. Cl. G06F 1/28

(52) U.S. Cl. 700/291

(57) ABSTRACT

A power consumption prediction system includes a plurality of power meters, each power meter being coupled to a particular consumer in a local usage area and configured to measure power provided to the particular consumer and to form a power usage profile for the particular consumer based on the measured power. The system also includes a consumption monitor in communication with the plurality of power meters that includes storage for storing power usage profiles received from the power meters and is configured to couple demographic information to the power usage profiles to form a local usage area profile. The system also includes a usage predictor that forms a usage prediction for a new local usage area, different than the local usage area, based on the local usage area profile and demographic information related to the new location usage area.

### BACKGROUND OF THE INVENTION

The subject matter disclosed herein relates to predicting the benefit of demand-response pricing in localized areas.

During moments of peak power consumption, a significant strain may be placed on utility providers and the power grid supplying power to consumers. These peak demand periods often occur during the hottest parts of a day, when large numbers of residential and commercial consumers are running heating, ventilation, and air conditioning (HVAC) appliances. In many cases, HVAC appliances may be running at consumers' homes even while the consumers are away.

During peak demand periods, a utility provider may desire to offer incentives to consumers not to run certain high-power-consuming appliances to prevent demand from exceeding the available power supply, which may result in power disruptions such as blackouts or brownouts or to reduce the need to purchase bulk power at high rates. These peak demand periods often occur during the hottest parts of a day, when large numbers of residential and commercial consumers are running HVAC appliances. As such, the peak demand could be reduced if some of these consumers agreed not to run their HVAC appliances (or other high-power-consumption appliances) during these peak demand periods. In exchange for agreeing not to run such appliances during peak demand periods, a utility provider could offer incentives, such as lower power rates or other benefits. As used herein, a request from a power utility to a consumer not to run a type of appliance at a certain period of high power demand, so as to mitigate excess power demand, is referred to as a “demand response event request.”

### BRIEF DESCRIPTION OF THE INVENTION

According to one aspect of the present invention, a power consumption prediction system that includes a plurality of power meters is disclosed. Each of the plurality of power meters is coupled to a particular consumer in a local usage area and configured to measure power provided to the particular consumer and to form a power usage profile for the particular consumer based on the measured power. The system of this aspect also includes a consumption monitor in communication with the plurality of power meters and that includes storage for storing power usage profiles received from the plurality of power meters and that is configured to couple demographic information to the power usage profiles to form a local usage area profile. The system of this aspect also includes a usage predictor that forms a usage prediction for a new local usage area, different than the local usage area, based on the local usage area profile and demographic information related to the new location usage area.

According to another aspect of the present invention, a method of predicting power consumption is disclosed. The method of this aspect includes: forming at a power meter a usage profile for each of a plurality of consumers in a local usage area, the usage profile for each of the plurality of consumers including an indication of the amount of power used in a specific time period; forming at a consumption monitor a profile for each of a plurality of load types and the usage of them per consumer type; collecting demographic information for a new local usage area that includes the consumer type of each consumer in the new local usage area; predicting the presence of load types in the new local usage area based on the profiles and the demographic information; and predicting a power consumption for the new local usage area based on the presence of load types.

According to another aspect of the present invention, an article of manufacture comprising machine-readable media having instructions encoded thereon for execution by a processor the execution of which causes the processor to perform a method is disclosed. The method that the instructions cause the processor to perform includes: receiving from a power meter a usage profile for each of a plurality of consumers in a local usage area, the profile including an indication of the amount of power used in a specific time period; forming a profile for each of a plurality of load types and the usage of them per consumer type; collecting demographic information for a new local usage area that includes the consumer type of each consumer in the new local usage area; predicting the presence of load types in the new local usage area based on the profiles and the demographic information; and predicting a power consumption for the new local usage area based on the presence of load types.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic block diagram of a distribution system that can be utilized to collect power usage information;

FIG. 2 is a flow chart illustrating a method according to one embodiment; and

FIG. 3 illustrates a computing system on which embodiments of the present invention may be implemented.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As noted above, during peak demand periods, a utility provider may desire to offer incentives to consumers not to run certain high-power-consuming appliances to prevent demand from exceeding the available power supply and avoid power disruptions such as blackouts or brownouts. These peak demand periods often occur during the hottest parts of a day, when large numbers of residential and commercial consumers are running HVAC appliances. As such, the peak demand could be reduced if some of these consumers agreed not to run their HVAC appliances (or other high-power-consumption appliances) during these peak demand periods.

In exchange for agreeing not to run such appliances during a demand response event occurring at peak demand periods, a utility provider could offer incentives, such as lower power rates or other benefits. The high power demand period during which a consumer has been requested not to run the type of device is referred to herein as a “demand response event.” In order to implement such an operating paradigm, the utility provider would need to provide certain hardware (e.g., special power meters) and a communication infrastructure. The combination of hardware and communication infrastructure is colloquially referred to as a “smart grid.” While a smart grid may lead to long term efficiency gains and, thus, cost savings, the initial capital investment required to can be high. As such, it is desirable to deploy such a system in areas where the savings will be felt.

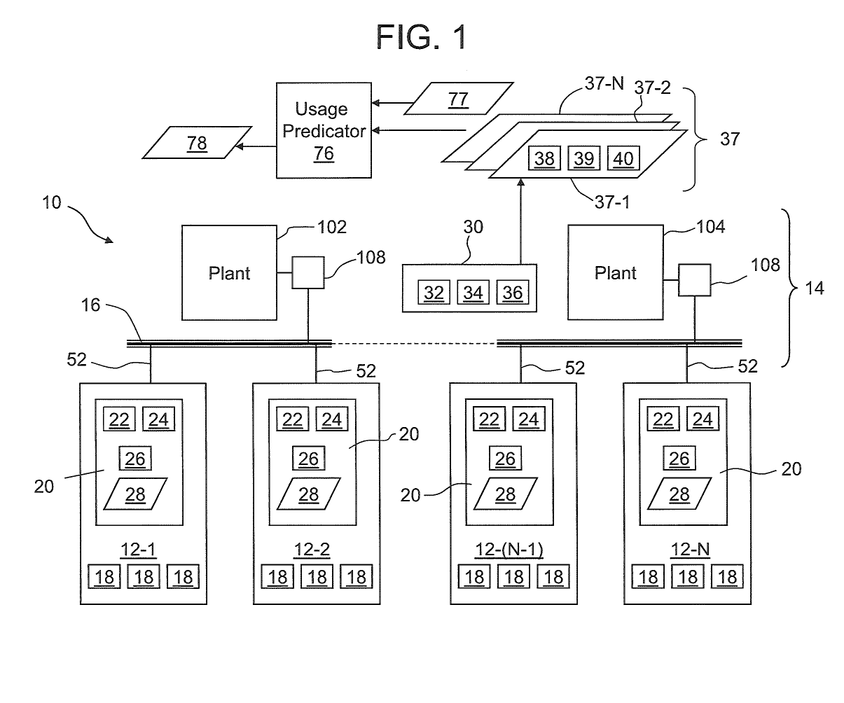

With the foregoing in mind, FIG. 1 represents a usage analysis system 10. In the system 10, consumers 12 may receive power from a utility provider 14 via a power grid 16. The power grid 16 can be formed, for example, by a plurality of alternating current (AC) power lines and can include feeder lines 52 that connect directly to a particular consumer 12.

The utility provider 14 can operate one or more power plants 102, 104 connected in parallel to the power grid 16 by multiple step-up transformers 108. The power plants 102, 104 may be coal, nuclear, natural gas, incineration power plants or a combination thereof. Additionally, the power plants 102, 104 may include one or more hydroelectric, solar, or wind turbine power generators. The step-up transformers 108 increase the voltage from that produced by the power plants 102, 104 to a high voltage, such as 138 kV for example, to allow long distance transmission of the electric power over the power grid 16. It shall be appreciated that additional components such as, transformers, switchgear, fuses and the like (not shown) may be incorporated into the power grid 16 to convert the power to correct levels for use by the consumers 12.

The power grid 16 may supply power to any suitable number of consumers 12, here labeled 12-1 to 12-N. These consumers 12 may represent, for example, residential or commercial consumers of power, each of which may consume power by running a number of appliances 18. The consumers 12 may include natural persons, business entities, commercial or residential properties, equipment, and so forth. The appliances 18 may include, for example, certain relatively high-power-consuming appliances 18, such as HVAC appliances, cooking appliances (e.g., ovens, ranges, cooktops, etc.), laundry machines (e.g., clothes washers and dryers), refrigerators and freezers, and so forth, as well as certain relatively low-power-consuming appliances 18, such as televisions, computers, and lights. Of course, each consumer 12 may be running a plurality of appliances 18 at any given point in time.

A local power meter 20 tracks the amount of power consumed by each consumer 12. According to one embodiment, one or more of the power meters 20 includes sampling circuitry 22, a consumer interface 24, and communication circuitry 26 with which the power meter 20 may communicate with the utility provider 14. In operation, during periods of peak power demand, or a “demand response event,” the utility provider 14 may desire to offer incentives to the consumers 12 in exchange for refraining from running certain high-power-consuming appliances 18 in a “demand response event request.” The utility provider 14 may communicate such a request to the consumer 12 via, for example, text messaging, phone, website, email, and/or the interface 24 of the meter 20 by way of the communication circuitry 26. In addition, it should be understood that in some embodiments, an appliance 18 may include a built-in demand response system, which may automatically respond to a demand response event request from a utility provider 14 by powering the appliance 18 off or refusing to turn the appliance 18 on during a demand response event.

In order to determine the correct pricing, either in the form of discounts for compliance or penalties for non-compliance, it may be beneficial to gather general power consumption related to a localized group of users. The system 10 can be utilized to gather such information. Once gathered, according to one embodiment, the consumption data can be combined with demographic data and/or environmental data to form a database of home profiles (usage profiles). These home/usage profiles can then be used to predict usage patterns in other areas by scaling or otherwise adjusting predicted usage. The predicted usage models can then be used to predict the effect of variable pricing and inform system deployment decisions.

The power meters 20 may take a variety of forms. In general, the meters 20 include sampling circuitry 22 that can measure voltage and current entering the consumer 12. In one embodiment, the sampling circuitry 22 of power meters 20 sample discrete power consumption by the consumers 12 to obtain power usage profiles 28. For example, the sampling circuitry 22 may measure the instantaneous power consumption or change in power consumption at specific intervals (e.g., every 0.1, 0.2, 0.5, 1, 2, 5, 10, 20, or 30 seconds, or every 1, 2, or 5 minutes, or other such intervals). In at least one embodiment, the sampling circuitry 22 samples the current power consumption of the consumer 12 at an interval long enough to provide privacy, such that relatively low-power-consuming appliances 18 generally are not particularly detectable according to the techniques discussed herein, but such that relatively high-power-consuming appliances 18 are detectable (e.g., approximately every 5-10 seconds or longer). The power meters 20 may communicate these power usage profiles 28 via the communication circuitry 26. This communication circuitry 26 may include wireless communication circuitry capable of communicating via a network such as a personal area network (PAN) such as a Bluetooth network, a local area network (LAN) such as an 802.11x Wi-Fi network, a wide area network (WAN) such as a 3G or 4G cellular network (e.g., WiMax), and/or a power line data transmission network such as Power Line Communication (PLC) or Power Line Carrier Communication (PLCC).

A usage monitor 30 associated with the utility provider 14 receives the power usage profiles 28 from some or all of the consumers 12. Although the usage monitor 30 is illustrated as being associated with the utility provider 14, the usage monitor 30 may be associated instead with a third party service, or may represent a capability of the power meter 20.

The usage monitor 30 includes a processor 32, memory 34, and storage 36 in one embodiment. The processor 32 may be operably coupled to the memory 34 and/or the storage 36 to form a local area usage profile 37. The local area usage profile 37 can include, for example, information related to usage for each consumer 12. Thus, as illustrated, the local area usage profile 37 includes individual local usage profiles 37-1 to 37-N for each consumer 12 in a local area. It shall be understood that the size and location of a particular local area can be determined based on particular requirements as will be fully understood by the skilled artisan upon review of the teachings herein.

Further, the usage monitor 30 may optionally also determine, based on the power usage profiles 28, the load types (e.g., particular types of appliances or other machines) present in each particular consumer 12. More particularly, the usage monitor 30 may compare the power usage profiles 28 received from the power meters 20 with various appliance profiles, which may be stored in the storage 36 and represent patterns of power consumption by certain types of appliances 18. Thus, some or all of the individual local area usage profiles 37-N can include an appliance inventory 38 for the particular consumer 12. It shall be understood, however, the meters 20 rather than the usage monitor 30 could create the appliance inventory 38.

In one embodiment, the local area usage profiles 37 also include, for each consumer 12, demographic information 39. The demographic information 39 can include, for example, the type of dwelling (single family detached home or condo), the number of people that occupy the consumer 12 and the like. This information could be compiled, for example, from census information, marketing databases, polling of the consumers 12, or by selecting the local area based such that it includes consumers 12 having known demographic information 39 or of consumers 12 that agree to providing demographic information 39 and utilizing a power meter 20 as described herein.

Further, the local area usage profiles 37 can also include environmental information 40 that is unique to the consumer 12 or general for the local usage area where the consumers 12 are located. This information can include, for example, the temperature profile of each day in the usage profile 37.

Electrical power is generally delivered to consumers at the same cost regardless of demand. That is, most markets do not allow for the real-time dynamic pricing where the price of power can vary based on demand. Some markets are opening to the possibility of providing such dynamic pricing. However, the cost of implementing a power distribution system that can provide for dynamic pricing can be high. As such, it is desirable to determine areas where dynamic pricing may have a significant impact for initial roll out. In addition, models of the effects of dynamic pricing may be required in order to convince a public utility commission that proposed rates will obtain the desired effects. Regardless of the ultimate use, actual data may be required to form models. The data can be, for example, the local area usage profiles 37.

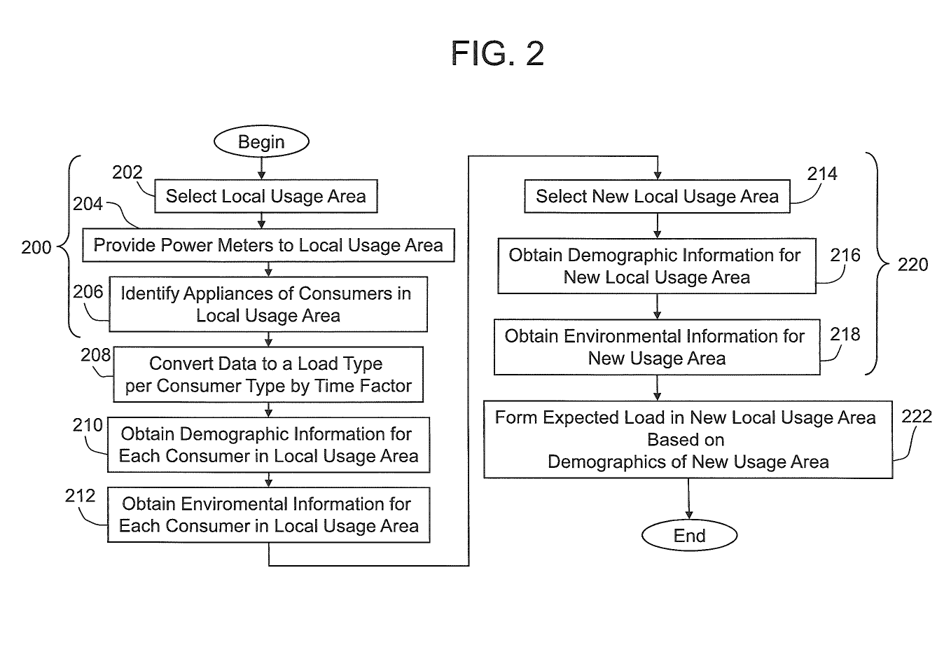

FIG. 2 is a flow-chart illustrating a method according to an embodiment of the present invention. The method begins at data collection stage 200. The data collection stage 200 can include several sub-stages. For example, the data collection stage 200 can include selecting a local usage area (sub-stage 202) and equipping consumers in the local usage area (sub-stage 204) with power meters capable of monitoring the consumption of power and creating a usage profiles that profiles power consumed by the premises. The data collection stage 200 can also include identifying the appliances in each consumer (sub-stage 206). This identification is performed by the usage monitor 30 of FIG. 1 in one embodiment. In another embodiment, the power meter itself can include hardware/software that allows it to identify the appliances in the consumer.

At stage 208 the data collected during the data collection stage 202 is converted into a database or other storage format of load types (e.g., appliances) and their usages per consumer. The database can also include an indication of the usage of the appliances by the time of day and/or season as well as an indication of the type of dwelling the particular consumer represents. Stage 208 can include determining, for example, that a particular single family dwelling in a particular area includes an HVAC system, a stove and refrigerator. As another example, it can be determined that a particular apartment includes a stove, a refrigerator, and two window-unit air conditioners.

At stage 210 demographic information is obtained for each consumer. The demographic information can include, or example, the number and ages of occupants or any other descriptor of permanent or semi-permanent occupants of the consumer. The demographic information can be created by polling the occupants for example. Of course, third party sources could provide the demographic information. The demographic information can be tied to each consumer and useful information can be obtained from it. For example, it may be determined that apartments utilize more window-unit air conditioners for longer periods of time during the day than single family homes and that the number of air conditioning units is correlated to the number of persons in a particular dwelling. Further, at stage 212, environmental information can be obtained for the local usage group as it has been found that environmental factors (such as temperature) are highly correlated to power usage.

In FIG. 1, the local area usage profiles 37 represents the combination of the data from stage 208 coupled to the demographic information of stage 210 and the environmental information of stage 212. Of course, the data could be kept in separate databases in one embodiment. At this point in the process, a baseline data set can be said to exist. From the base line data set, usage predictions for a new local usage area can be made based on demographic and/or environmental information of the new local usage area. That is, usage profiles can be predicted without requiring actually monitoring the usage in the new local usage area.

At stage 214 a new local area is selected and, at stage 216 demographic information from the new local area is obtained. The demographic information can be obtained as described above, for example. In addition, at stage 218, environmental information for the new local usage area is obtained. Stages 214-218 can collectively be referred to as a second data collection stage 220.

From the usage profiles 37 (or separate sets of date), at stage 222 simulations of loads that are expected in the new local usage areas is created from the baseline data set and the data collected in the second data collection stage can be created. For example, if the new local area contains only single family homes, the usage profiles 37 related to single family homes are selected. Then, based on the demographic information 39 for homes in the new local usage area, the amount of usage can be predicted. Further, the predictions can be scaled, for example, based on differences in environmental factors. For example, the predictions could be scaled upwards in cases where new local usage area experiences higher average temperatures than in the local area from which the usage profiles were created.

Referring again to FIG. 1, the predictions can be formed, for example, by a usage predictor 76. The usage predictor 76 compares demographic information 39 from the usage profiles 37 to those for the new local usage area (demographic data 77) and produces usage predictions 78 as described above. The usage predictor 76 can be maintained by the utility provider 14 or by a third party or some combination thereof.

Operating in the above manner has the technical effect of allowing for the prediction of power usage in a local area without having to actually measure usage patterns in that area. Additionally, the utility provider may be able to predict the appliances in a consumer based on the type of dwelling and available demographic information.

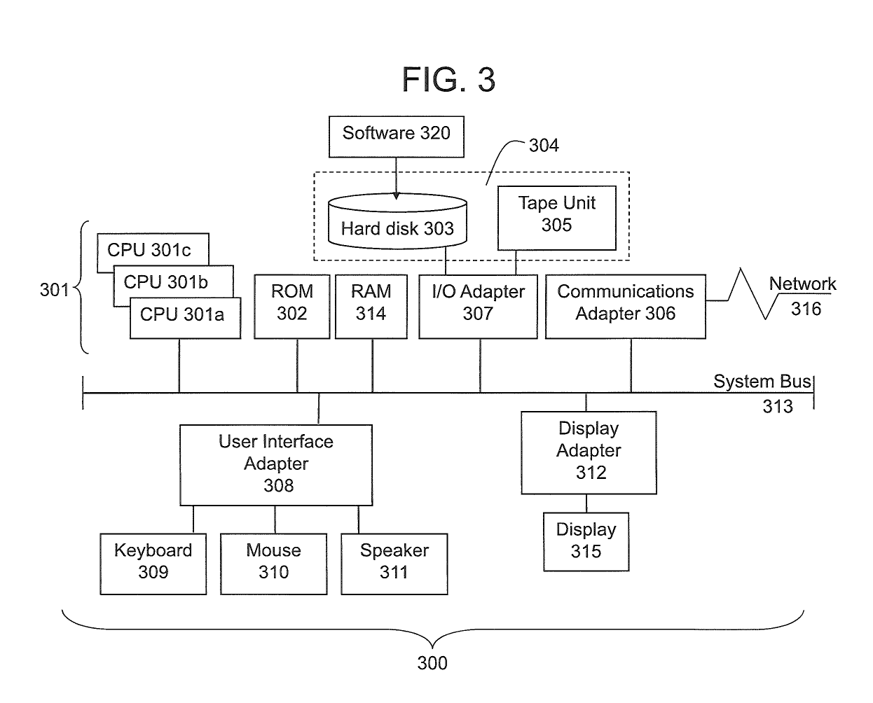

FIG. 3 shows an example of a computing system 300 on which embodiments of the present invention may be implemented. The system 300 illustrated in FIG. 3 includes one or more central processing units (processors) 301a, 301b, 301c, etc. (collectively or generically referred to as processor(s) 301). Processors 301 are coupled to system memory 314 (RAM) and various other components via a system bus 313. Read only memory (ROM) 302 is coupled to the system bus 313 and may include a basic input/output system (BIOS), which controls certain basic functions of system 300.

FIG. 3 further depicts an input/output (I/O) adapter 307 and a network adapter 306 coupled to the system bus 313. I/O adapter 307 may be a small computer system interface (SCSI) adapter that communicates with a hard disk 303 and/or tape storage drive 305 or any other similar component. I/O adapter 307, hard disk 303, and tape storage device 305 are collectively referred to herein as mass storage 304. In one embodiment, the mass storage 304 and the system memory 314 can collectively be referred to as memory, and can be distributed across several computing devices.

A network adapter 306 interconnects bus 313 with an outside network 316 enabling system 300 to communicate with other such systems. A screen (e.g., a display monitor) 315 is connected to the system bus 313 by a display adaptor 312. The system 300 also includes a keyboard 309, mouse 310, and speaker 311 all interconnected to the bus 313 via user interface adapter 308.

It will be appreciated that the system 300 can be any suitable computer or computing platform, and may include a terminal, wireless device, information appliance, device, workstation, mini-computer, mainframe computer, personal digital assistant (PDA) or other computing device. It shall be understood that the system 300 may include multiple computing devices linked together by a communication network. For example, there may exist a client-server relationship between two systems and processing may be split between the two.

It shall further be appreciated that embodiments of the present invention can be embodied as an article of manufacture that includes machine-readable media including having instructions encoded thereon for execution by a processor such as processing units 301. The instructions cause the processor to perform the methods disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A power consumption prediction system comprising:
a plurality of power meters, each of the plurality of power meters being coupled to a particular consumer in a local usage area and configured to measure power provided to the particular consumer and to form a power usage profile for the particular consumer based on the measured power;
a consumption monitor in communication with the plurality of power meters and including storage for storing power usage profiles received from the plurality of power meters, the consumption monitor configured to couple demographic information to the power usage profiles to form a local usage area profile; and
a usage predictor that forms a usage prediction for a new local usage area, different than the local usage area, based on the local usage area profile and demographic information related to the new location usage area.

2. The power consumption prediction system of claim 1, wherein the predicted usage is formed without monitoring usage of consumers in the new local usage area.

3. The power consumption prediction system of claim 1, wherein the plurality of power meters include:
storage containing appliance profiles representative of a pattern of power consumption by different types of appliances; and
data processing circuitry configured to compare a power usage profile representing power consumption by a consumer at least over a period of time to the appliance profile to determine whether the consumer possesses a particular appliance.

4. The power consumption prediction system of claim 1, wherein the consumption monitor includes:
storage containing appliance profiles representative of a pattern of power consumption by different types of appliances; and
data processing circuitry configured to compare a power usage profile representing power consumption by a consumer at least over a period of time to the appliance profile to determine whether the consumer possesses a particular appliance.

5. The power consumption prediction system of claim 1, wherein the usage predictor forms the predicted usage based on differences in environmental information in the local usage area and the new local usage area.

6. A method of predicting power consumption, the method comprising:
forming at a power meter a usage profile for each of a plurality of consumers in a local usage area, the usage profile for each of the plurality of consumers including an indication of the amount of power used in a specific time period;
forming at a consumption monitor a profile for each of a plurality of load types and the usage of them per consumer type;
collecting demographic information for a new local usage area that includes the consumer type of each consumer in the new local usage area;
predicting the presence of load types in the new local usage area based on the profiles and the demographic information; and
predicting a power consumption for the new local usage area based on the presence of load types.

7. The method of claim 6, wherein the power meters form the usage profiles such that it includes an indication of load types in the consumer.

8. The method of claim 6, wherein the consumption monitor determines which of the plurality of load types are present in the consumer.

9. The method of claim 6, wherein the power consumption is predicted without using measurements of power usage in the new local usage area.

10. The method of claim 6, wherein predicting a power consumption includes comparing environmental data from the local usage area to the environmental data from the new local usage area.

11. An article of manufacture comprising machine-readable media having instructions encoded thereon for execution by a processor the execution of which causes the processor to perform a method comprising:
receiving from a power meter a usage profile for each of a plurality of consumers in a local usage area, the profile including an indication of the amount of power used in a specific time period;
forming a usage profile for each of a plurality of load types and the usage of them per consumer type;
collecting demographic information for a new local usage area that includes the consumer type of each consumer in the new local usage area;
predicting the presence of load types in the new local usage area based on the profiles and the demographic information; and
predicting a power consumption for the new local usage area based on the presence of load types.

12. The article of manufacture of claim 11, wherein the power meters form the usage profile again such that they include an indication of load types at the consumer.

13. The article of manufacture of claim 11, wherein a consumption monitor determines which of the plurality of load types is present at the consumer.

14. The article of manufacture of claim 11, wherein the power consumption is predicted without using measurements of power usage in the new local usage area.
